(19) United States
(12) Patent Application Publication
(10) Pub. No.: US 2018/0184598 A1
(43) Pub. Date: Jul. 5, 2018

(54) DEVICE, SYSTEM AND METHOD FOR SUPPORTING PLANTS

(71) Applicants: Norman Lee Pearce, Chesapeake, VA (US); Rhonda Fly Pearce, Chesapeake, VA (US)

(72) Inventors: Norman Lee Pearce, Chesapeake, VA (US); Rhonda Fly Pearce, Chesapeake, VA (US)

(21) Appl. No.: 15/856,431

(22) Filed: Dec. 28, 2017

Related U.S. Application Data
(60) Provisional application No. 62/441,673, filed on Jan. 3, 2017.

(51) Int. Cl. A01G 9/12

(52) U.S. Cl. CPC A01G 9/122; A01G 9/126

(57) ABSTRACT

Systems, methods, and devices are provided for supporting plants when a plant increases in height and/or has laterally uneven weight distribution. In addition or alternatively, systems, methods, and devices can be deployed to stabilize plant support structures by further securing such structure to ground. Entire devices or components thereof can be manufactured from various rigid materials such as metal, wood, and/or plastic. Devices can be manufacture from recycled material such as recycled plastic molded to required configuration.

### CROSS-REFERENCE TO RELATED APPLICATIONS

This application claims priority to prior U.S. Provisional Patent Application No. 62/441,673, filed Jan. 3, 2017, the entire content of which is incorporated herein by reference.

### BACKGROUND OF THE INVENTION

### 1. Field of Invention

The present invention relates to systems, devices, and methods for providing support to plants to promote plant growth.

### 2. Description of Related Art

Conventional plant support systems and devices include cages, which are particularly useful for supporting fruit bearing plants that have vines, or plans with branches that are not very resilient. As illustrated in FIG. 1, a convention cage 10 includes a frame 12 generally comprising rigid wire rings concentrically attached to rigid rods to form a cylindrical or conical structure with the lowest or base ring 14 resting on the ground 20 where a plant to be supported by cage 10 is located generally toward the center 22 of the lowest or base ring 14 of frame 12.

A drawback of such conventional cages is their tendency to fall over during windy conditions, or when plants become taller than the cage, or when the fruit become too heavy or unevenly distributed with respect to the cage. Accordingly, there is a need for a tool or system that can support conventional cages, or provide stand-alone support to plants, and address at least the above-noted drawback of conventional support devices.

### SUMMARY OF THE INVENTION

Exemplary embodiments of the present invention address at least these issues by providing systems, methods, and devices for supporting plants when a plant increases in height and/or has laterally uneven weight distribution. Further exemplary embodiments of the present invention provide in addition or alternatively, systems, methods, and devices that can be deployed to stabilize plant support structures by further securing such structure to ground.

According to exemplary implementations of disclosed embodiments, entire devices or components thereof can be manufactured from various rigid materials such as metal, wood, and/or plastic. According to yet further exemplary implementations of disclosed embodiments, an entire stabilization devices and/or components thereof can be manufacture from recycled materials such as recycled plastic molded to required configuration.

An exemplary embodiment of the present invention provides a plant supporting device having a rigid body including a top portion and a bottom portion tapering to a tip with a slot extending from the tip toward the top portion, said slot having a predefined width and length sufficient to accommodate a rigid rod or wire passing therethrough. The wire or rod can be slidably positioned through the slot, such that the wire or rod is secured within the slot when the tapered portion of the rigid body is driven into ground.

Another exemplary embodiment of the present invention provides a system for supporting a plant, the system comprising a cage to essentially surround a plant, the cage including a base wire, and further comprising a rigid body including a top portion and a bottom portion tapering to a tip with a slot having a predefined width and length sufficient to accommodate the base wire of the cage passing therethrough to secure the base wire within the slot when the tapered portion of the rigid body is driven into the ground.

Yet another exemplary embodiment of the present invention provides a method for supporting a plant, the method includes positioning a cage with a base wire to essentially surround a plant, positioning with respect to the base wire a rigid body having a top portion and bottom portion tapering to a tip with a slot extending from the tip toward the top portion, sliding the base wire through the slot, and driving the rigid body into ground such that said base wire is secured within the slot when the tapered portion is inserted into ground.

Still further exemplary embodiment of the present invention provides a device or method where a rigid body having

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein

FIG. 1 provides an illustrative example of a conventional plant support device.

FIG. 2A is a generalized illustration of a side view of a support device according to an exemplary embodiment of the disclosure.

FIG. 2B is a generalized illustration of another side view of a support device according to an exemplary embodiment of the disclosure as illustrated in FIG. 2A.

FIGS. 2C, 2D, and 2E are generalized illustrations of top views of a support device according to an exemplary embodiment of the disclosure as illustrated in FIG. 2A and/or FIG. 2B.

FIG. 3 is a generalized illustration of a side view of a support device according to another exemplary embodiment of the disclosure.

FIG. 4 is a generalized illustration of a side view of a support device according to yet another exemplary embodiment of the disclosure.

FIG. 5A is a generalized illustration of a side view of a support device according to still another exemplary embodiment of the disclosure.

FIG. 5B is a generalized illustration of a top view of a support device according to an exemplary embodiment of the disclosure as illustrated for example in FIG. 5A.

FIG. 6 is a generalized illustration of system according to an exemplary embodiment of the disclosure including one or more support devices illustrated in any one of FIGS. 2A through 5B.

FIG. 7 is a generalized illustration of a system and method including deployment of a system as illustrated in the example of FIG. 6.

FIG. 8 is another generalized illustration of a system and method including deployment of a system as illustrated in the example of FIG. 6.

FIG. 9 is a generalized illustration of a system and method including deployment of one or more devices as illustrated in the examples of any one of FIGS. 2A through 5B.

FIG. 10 is another generalized illustration of a system and method including deployment of one or more devices as illustrated in the examples of any one of FIGS. 2A through 5B.

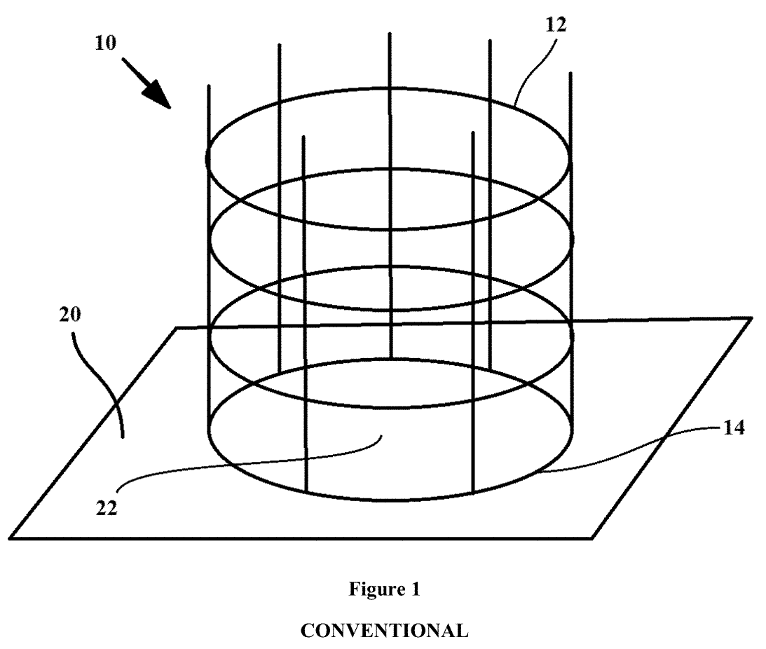

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Exemplary embodiments of the present invention will now be described in detail with reference to the annexed drawings. In the following description, a detailed description of known functions and configurations incorporated herein has been omitted for clarity and conciseness. Specific dimensions of various components provided in the drawings are to facilitate understanding of exemplary embodiment s of the present invention.

Exemplary embodiments of the present invention provide systems, methods, and devices that can provide further support, or stabilize, conventional plant support structures, such as tomato cages, during windy days or evening storms.

Support devices according to exemplary implementations of the present invention can provide support and prevent a conventional plant cage from falling over when a plant grows higher than the cage and/or has a tendency of allowing too much weight or putting too much pressure on one side of the cage.

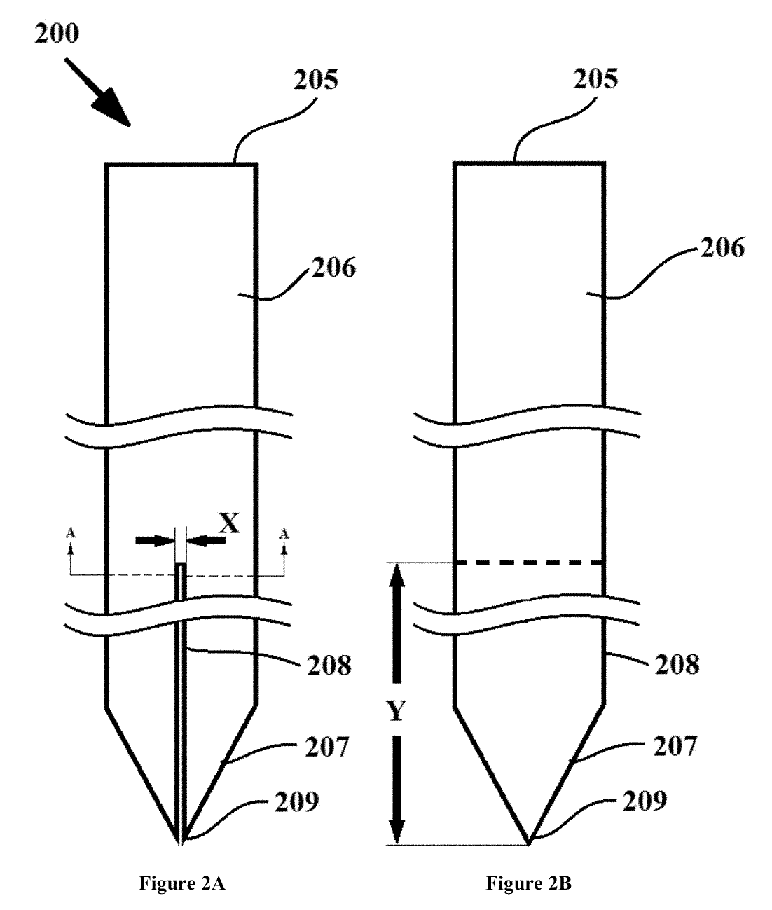

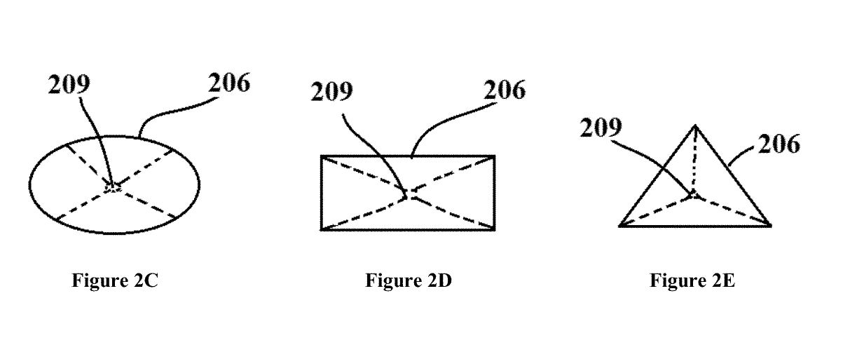

Referring to FIGS. 2A-2E, an exemplary embodiment of the present invention provides a device 200, which has a stake-like shape formed from materials such as wood, plastic, or metal, or combinations thereof, and can be solid or hollow such as a metal or PVC pipe. In an exemplary implementations, the entire stabilization device 200, and/or components thereof which are described below, can be manufacture from recycled materials such as recycled plastic molded, for example injection molded, to required configuration or configurations.

In an exemplary implementation, device 200 has a rigid body 206 including a top portion 205 and tapered bottom portion 207 which ends essentially in a tip 209 to facilitate insertion of device 200 into ground. As illustrated in a front and side views of FIGS. 2A and 2B, body 206 has a slot 208, which has a width X, and extends longitudinally a length Y, essentially through the center axis of body 206 from tip 209 toward top portion 205.

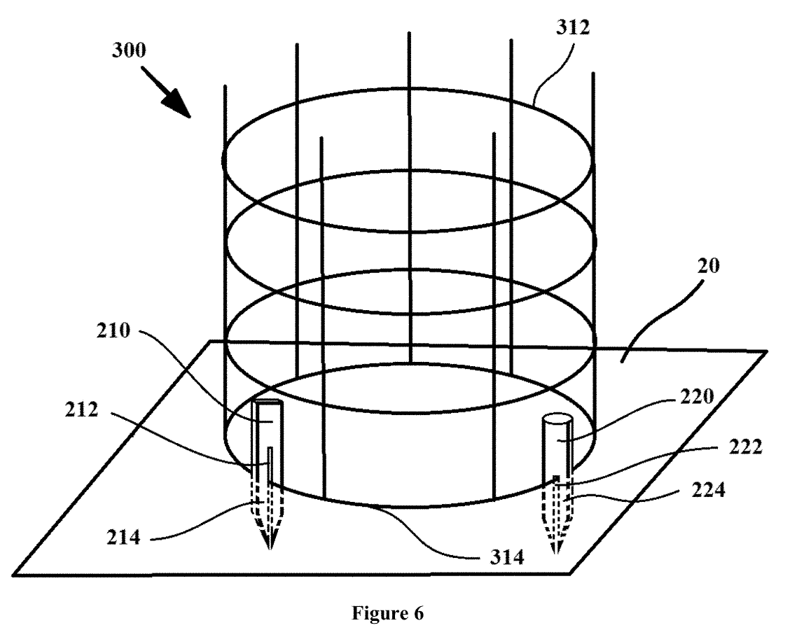

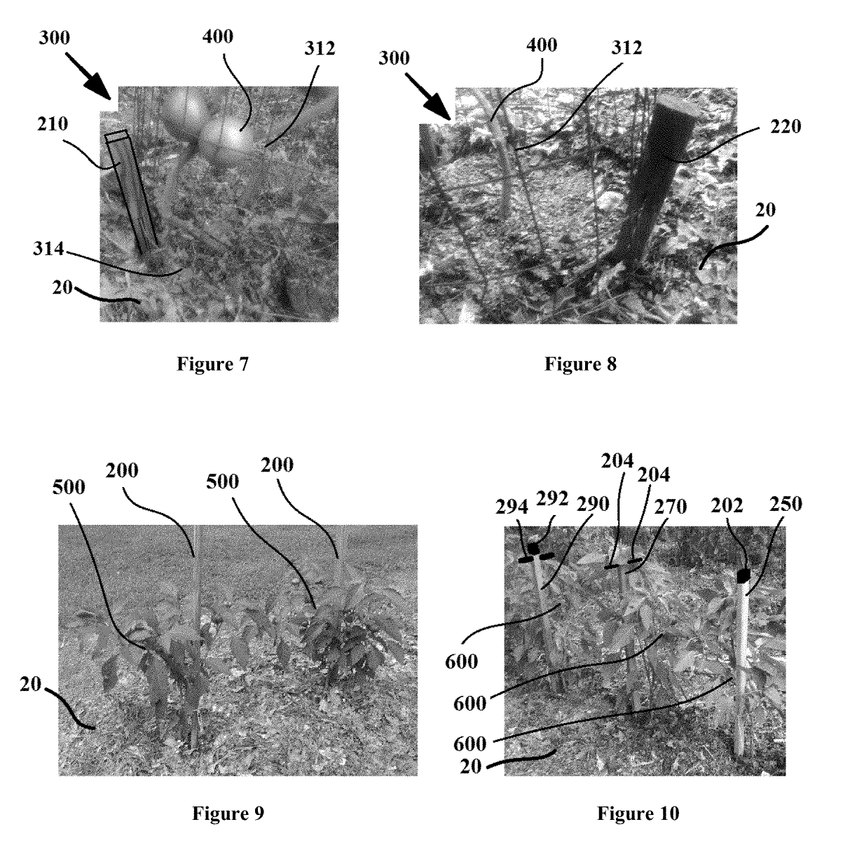

As illustrated diagrammatically in FIGS. 2A and 2B, the overall length of body 206 as well as the length of tapered portion 207 can vary depending on the application of device 200, as illustrated and described further with reference to FIGS. 6-10. In an exemplary, advantageous, implementation of embodiments of the present invention, width X of slot 208 is about ⅛″ or wide enough to accommodate thickness of a wire of a conventional cage. Length Y of slot 208 can be about 5″, or long enough to secure base wire of a cage as described further with reference to FIG. 6, but less than the length of entire body 206 to ensure that body 206 maintains its rigidity.

As illustrated diagrammatically in FIGS. 2C-2E, which show cross sectional views along A-A of FIG. 2A, according to exemplary implementations of the present invention, body 206 of device 200 can be essentially round (FIG. 2C), square or rectangular (FIG. 2D), or any shape (FIG. 2E). As noted previously, body 206 can be solid or hollow, as long as it is strong enough to get deep enough into ground when hammered or driven into the ground, as described further with reference to FIG. 6.

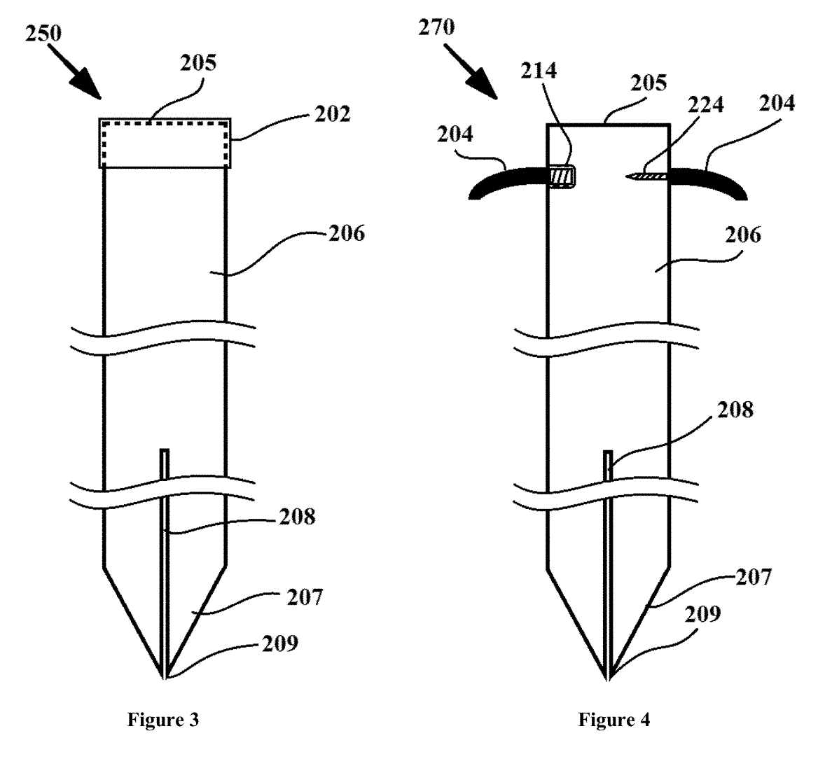

In an exemplary embodiment of the present invention as illustrated in FIG. 3, device 250 includes cap 202 essentially covering top 205 of body 206. Cap 202 is preferably made of hardened material in order to maintain integrity of body 206 when device is hammered into ground for example by application of hammering blows at top 205. Cap 202 can be integrally formed with body 206, securely attached to top 205, or removably attached to top 205 during the hammering process.

In another exemplary embodiment of the present invention as illustrated in FIG. 4, device 270 includes one or more handles 204 to facilitate extraction of device 270 from ground. In an exemplary implementation, handle 204 can be fixed to body 306 by means of a screw 224, for example screwed directly into a body 206, for example made of wood. In another exemplary implementation, handle 204 can be fixed to body 206 by means of a tab 214 that can be screwed into or snapped into a complimentary opening or cavity in body 206.

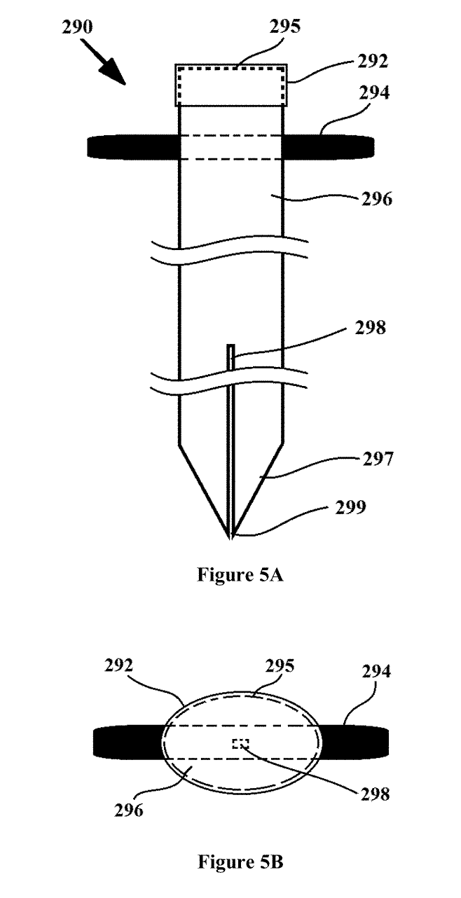

In yet another exemplary embodiment of the present invention as illustrated in FIGS. 5A and 5B, device 290 can include both, cap 292 (configured on top 295 of body 296 similarly or exactly as cap 205 of FIG. 3 to facilitate insertion of tip 299 and at least some of tapered portion 297 and slot 298 into ground) and one or more handles 204 (configured similarly or exactly as shown in the example of FIG. 4) to facilitate extraction of device 290 from ground. In an exemplary implementation, device 290 includes handle 294 (for example, instead of handles 204), which can be formed as a single piece that extends through body 296 as shown in FIG. 5B. Handle 294 can be fixed to body 296 by means of a firm fit within body. In yet other exemplary implementation of the present invention, handles 204 or 294 can be integrally formed with body 206 or 296.

Referring to FIGS. 6-8, plan support system 300 according to an exemplary embodiment of the present invention comprises a cage 312 and one or more devices or stakes 210, 220 (such as any of the devices or stakes 200, 250, 270, and/or 290 shown in the examples of FIGS. 2A-5). Each stake 210,220 includes a respective slot 212,222 so that a bottom wire 314 of a cage 312 goes through the slot 212,222 in respective stake 210,220. A user can position cage 312 as desired with respect to a plant 400, slide bottom wire 314 (or any other cage wire that be secured with respect to ground by device 290) through the slot 212,222, and then hammer top of respective stake 212,222 into ground 20 until tapered portion 214,224 of respective stake 212,222 is at desired depth sufficient to secure cage 312 in place. As described above with respect to FIGS. 2A-2E, stakes 210,220 can be round 220 or square 210, or of any shape. Stakes 210,220 can also be solid or hollow, as long as they are strong enough to be hammered, or otherwise driven, deep enough into ground 20.

As illustrated in the examples of FIGS. 9 and 10, according to non-limiting embodiments of the present invention, stakes 200, 250, 270, 290 can be of any length including long enough to support young fruit 500 and regular trees 600 without a cage as long as they are sufficiently rigid and firmly driven into the ground 20.

Other objects, advantages and salient features of the invention will become apparent to those skilled in the art from the details provided, which, taken in conjunction with the accompanying drawing figures, disclose exemplary embodiments of the invention

While the invention has been shown and described with reference to a certain exemplary embodiment thereof, it will be understood by those skilled in the art that various changes in form and details may be made therein without departing from the spirit and scope of the invention as defined by the appended claims and the full scope of equivalents thereof

We claim:

1. A plant supporting device comprising:
a rigid body including a top portion and a bottom portion, said bottom portion tapering to a tip; and
a slot extending from said tip toward said top portion, said slot having a predefined width and length sufficient to accommodate a rigid rod or wire passing therethrough,
wherein said wire or rod is slidably positioned through said slot, such that said wire or rod is secured within said slot when said tapered portion of said rigid body is driven into ground.

2. The device of claim 1 further comprising a cap positioned at said top portion of said body to maintain integrity of said body when said body is driven into ground.

3. The device of claim 1 further comprising at least one handle integrally or removably formed with respect to said top portion of said body and essentially perpendicular to exterior surface of said body.

4. The device of claim 1, wherein
said rigid body comprises a cross section having at least one of an essentially round shape, an essentially square shape, an essentially rectangular shape, an essentially triangular shape.

5. The device of claim 1, wherein said rigid body is solid or hollow.

6. The device of claim 1, wherein said body comprises at least one of metal, wood, and plastic.

7. The device of claim 1, wherein said body is molded from recycled plastic.

8. A system for supporting a plant, said system comprising:
a cage to essentially surround a plant, said cage including a base wire; and
a rigid body including:
a top portion and a bottom portion, said bottom portion tapering to a tip; and
a slot extending from said tip toward said top portion, said slot having a predefined width and length sufficient to accommodate said base wire passing therethrough,
wherein said base wire is slidably positioned through said slot, such that said base wire is secured within said slot when said tapered portion of said rigid body is driven into ground.

9. The system of claim 8 further comprising a cap positioned at said top portion of said body to maintain integrity of said body when said body is driven into ground.

10. The system of claim 8 further comprising at least one handle integrally or removably formed with respect to said top portion of said body and essentially perpendicular to exterior surface of said body.

11. The system of claim 8, wherein
said rigid body comprises a cross section having at least one of an essentially round shape, an essentially square shape, an essentially rectangular shape, an essentially triangular shape.

12. The system of claim 8, wherein said rigid body is solid or hollow.

13. The system of claim 8, wherein said body comprises at least one of metal, wood, and plastic.

14. The system of claim 8, wherein said body is molded from recycled plastic.

15. A method for supporting a plant, said method comprising:
positioning a cage to essentially surround a plant, said cage including a base wire;
positioning a rigid body with respect to said base wire, said rigid body including
a top portion and a bottom portion, said bottom portion tapering to a tip, and
a slot extending from said tip toward said top portion, said slot having a predefined width and length sufficient to accommodate said base wire passing therethrough;
sliding said base wire through said slot; and
driving said rigid body into ground such that said base wire is secured within said slot when said tapered portion is inserted into ground.

16. The method of claim 15 further comprising positioning a cap at said top portion of said body to maintain integrity of said body when said body is driven into ground.

17. The method of claim 15 further comprising attaching at least one handle to said top portion of said body and essentially perpendicular to exterior surface of said body.

18. The method of claim 15, wherein
said rigid body comprises a cross section having at least one of an essentially round shape, an essentially square shape, an essentially rectangular shape, an essentially triangular shape.

19. The method of claim 15, wherein said rigid body is solid or hollow.

20. The method of claim 1, wherein
said body comprises at least one of metal, wood, plastic, and at least one of said top and said bottom portion molded from recycled plastic.
